(19) United States
(12) Patent Application Publication
(10) Pub. No.: US 2026/0216846 A1
(43) Pub. Date: Jul. 30, 2026

(54) ADAPTER TOOLS, SYSTEMS, AND METHODS FOR ROTATING PARTS

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/457,134

(22) Filed: Jan. 22, 2026

Related U.S. Application Data
(60) Provisional application No. 63/749,311, filed on Jan. 24, 2025.

(51) Int. Cl. B25B 13/46; B25B 23/00

(52) U.S. Cl. CPC B25B 13/463; B25B 23/0021; B25B 23/0035

(57) ABSTRACT

An adapter system for a primary tool defining at least one drive portion configured to displace a part relative to a structure, the adapter system comprising a tool body, a ratchet system, and a socket assembly. The tool body defines first and second drive openings, a fixed transfer opening, and a ratchet transfer opening. The ratchet system is supported by the ratchet transfer opening. The socket assembly supported by the ratchet system. The adapter system is configured to operate in at least one of a first mode and a second mode, where in the first mode, the at least one drive portion is arranged in the first drive opening and the part is arranged in the fixed transfer opening, and in the second mode, the at least one drive portion is arranged in the second drive opening and the part is arranged in the socket assembly.

### RELATED APPLICATIONS

This application (Attorney's Ref. No. P220739) claims benefit of U.S. Provisional Application Ser. No. 63/749,311 filed Jan. 24, 2025, the contents of which are incorporated herein by reference.

### TECHNICAL FIELD

The present invention relates to systems and methods for rotating a part and, in particular, to adapter tools, systems, and methods for removing and installing parts.

### BACKGROUND

Parts such as nuts and bolts are typically rotated for removal and installation. Parts that are used in vehicles such as automobiles and trucks often require installation using a predetermined amount of torque. Further, parts for vehicles such as automobiles and trucks are often used in harsh environments that can render removal of the part difficult. The need thus exists for an adapter tool configured to facilitate both installation of a part using a predetermined amount of torque and removal of a part that has been subjected to harsh environments.

### SUMMARY

The present invention may be embodied as an adapter system for a primary tool defining at least one drive portion configured to displace a part relative to a structure, the adapter system comprising a tool body, a ratchet system, and a socket assembly. The tool body defines first and second drive openings, a fixed transfer opening, and a ratchet transfer opening. The ratchet system is supported by the ratchet transfer opening. The socket assembly is supported by the ratchet system. The adapter system is configured to operate in at least one of a first mode and a second mode, where in the first mode, the at least one drive portion is arranged in the first drive opening and the part is arranged in the fixed transfer opening, and in the second mode, the at least one drive portion is arranged in the second drive opening and the part is arranged in the socket assembly.

The present invention may be embodied as a method for adapting a primary tool defining at least one drive portion configured to displace a part relative to a structure. A tool body is provided, the tool body defining first and second drive openings, a fixed transfer opening, and a ratchet transfer opening. A ratchet system is provided supported by the ratchet transfer opening. A socket assembly is provided supported by the ratchet system. The tool body is configured to operate in at least one of a first mode and a second mode to displace the part relative to the structure, where in the first mode, the at least one drive portion is arranged in the first drive opening and the part is arranged in the fixed transfer opening, and in the second mode, the at least one drive portion is arranged in the second drive opening and the part is arranged in the socket assembly.

The present invention may further be embodied as an adapter system for a primary tool defining a first system defining and a second system configured to displace a part relative to a structure, the adapter system comprising a tool body, a ratchet system and a socket assembly. The tool body defines first and second drive openings, a fixed transfer opening, and a ratchet transfer opening. The ratchet system is supported by the ratchet transfer opening. The socket assembly is supported by the ratchet system. The adapter system is configured to engage the primary tool in at least one of a first mode and a second mode, where in the first mode, at least a portion of the first system is configured to engage the first drive opening and the fixed transfer opening engages at least a portion of the part, and in the second mode, at least a portion of the second system is configured to engage the second drive opening and the socket assembly is configured to engage at least a portion of the part. Operation of the primary tool causes the adapter system to be displaced relative to the primary tool and the adapter system causes the part to be displaced relative to the structure.

### BRIEF DESCRIPTION OF THE DRAWINGS

FIG. 1 is a front view showing a first example adapter tool of the present invention and an example part to be removed using the first example adapter tool;

FIG. 2 is a perspective view of a breaker system that may be used in connection with the first example adapter tool;

FIG. 3 is a perspective view of a torque wrench system that may be used in connection with the first example adapter tool;

FIG. 4 is a front view illustrating use of the breaker bar to displace a part using the first example adapter tool;

FIG. 5 is a front view illustrating use of the torque wrench to displace a part using the first example adapter tool;

FIG. 6 is a side elevation view illustrating use of the torque wrench to displace a part using the first example adapter tool;

FIG. 7 is a section view taken along lines 7-7 in FIG. 5 illustrating connection of the torque wrench to the first example adapter tool;

FIG. 8 is a section view taken along lines 8-8 in FIG. 7 illustrating connection of the torque wrench to the first example adapter tool;

FIGS. 9 and 10 are exploded, perspective views depicting connection of a socket assembly to a ratchet system of the first example adapter tool;

FIGS. 11-13 are section views depicting connection of the socket assembly to the ratchet system of the first example adapter tool;

FIG. 14 is a front view of the first example adapter tool;

FIG. 15 is a back view of the first example adapter tool;

FIGS. 16 and 17 are section views depicting connection of the rachet system to the tool body of the first example adapter tool;

FIG. 18 is a front view showing a second example adapter tool of the present invention.

### DETAILED DESCRIPTION

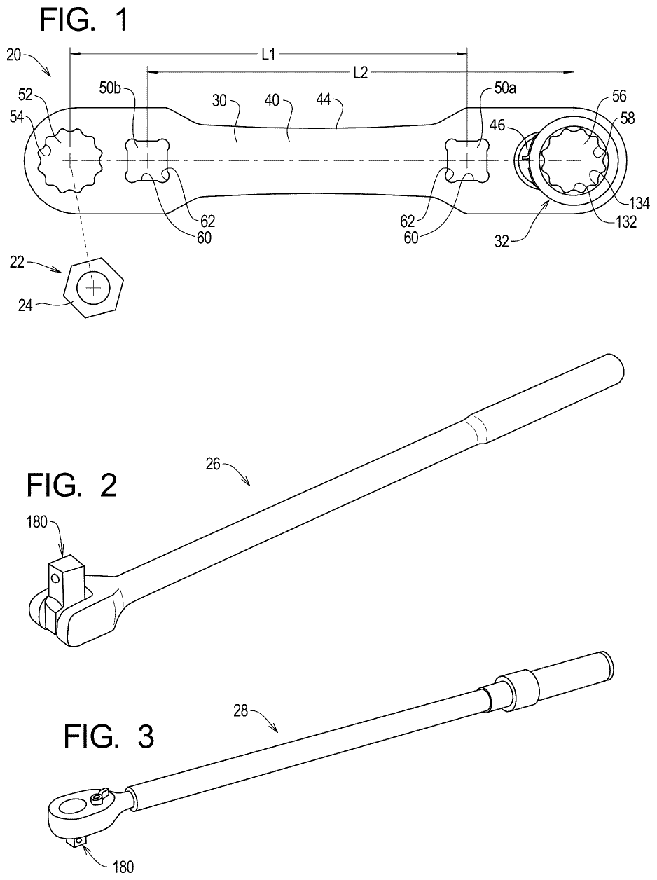

Referring initially to FIG. 1 of the drawing, depicted therein is a first example adapter tool 20 constructed in accordance with, and embodying, the principles of the present invention. The first example adapter tool 20 is configured to be used to rotate an example part 22 as depicted in FIG. 1. The example part 22 is a nut or bolt defining a head portion 24. The first example adapter tool 20 is used in conjunction with primary tool such as a breaker system 26 as shown in FIG. 2 and/or a torque wrench system 28 as shown in FIG. 3. The example part 22, torque wrench system 28, and breaker system 26 are or may be conventional and will not be described herein beyond that extent helpful to a complete understanding of the present invention.

The first example adapter tool 20 comprises a tool body 30, a ratchet system 32, and a socket assembly 34. The example tool body 30 defines a first surface 40, a second surface 42, and a perimeter surface 44. Formed in the first surface 40 adjacent to the ratchet system 32 is an access notch 46. Formed in the tool are first and second drive openings 50a and 50b, a fixed transfer opening 52 defining a fixed transfer opening internal surface 54, and a ratchet transfer opening 56 defining a ratchet opening internal surface 58. The ratchet opening internal surface 58 defines a body retaining groove 58a. The body retaining groove 58a intersects the access notch 46 at two locations. The example first and second drive openings 50a and 50b are arranged between the fixed transfer opening 52 and the ratchet transfer opening 56. The first drive opening 50a is located adjacent to the ratchet transfer opening 56, and the second drive opening 50b is located between the first drive opening 50a and the fixed transfer opening 52.

The example openings 50, 52, 54, and 56 extend through the tool body 30 between the first and second body surfaces 40 and 42, but cavities formed in one or both of the first and second body surfaces 40 and 42 may be used in addition or instead. The example tool body 30 is sized, dimensioned, and made of a solid piece of material, typically metal, capable of transmitting forces between the primary tool 26 or 28 and the part 22 as will be described in further detail below. However, a multi-part body structure may be used to form the tool body 30 of the present invention.

The example first and second drive openings 50a and 50b are the same and each define a plurality of drive opening drive surfaces 60 and a plurality of drive opening corner surfaces 62. A drive opening retaining groove or recess 64 is formed in at least one of the drive opening drive surfaces 60. As depicted in FIGS. 1, 4, 5, 7, and 8, the example first and second drive openings 50a and 50b define conventional square drive openings, but other drive configurations may be used to transfer loads from the primary tool 26 or 28 to the first example adapter tool 20.

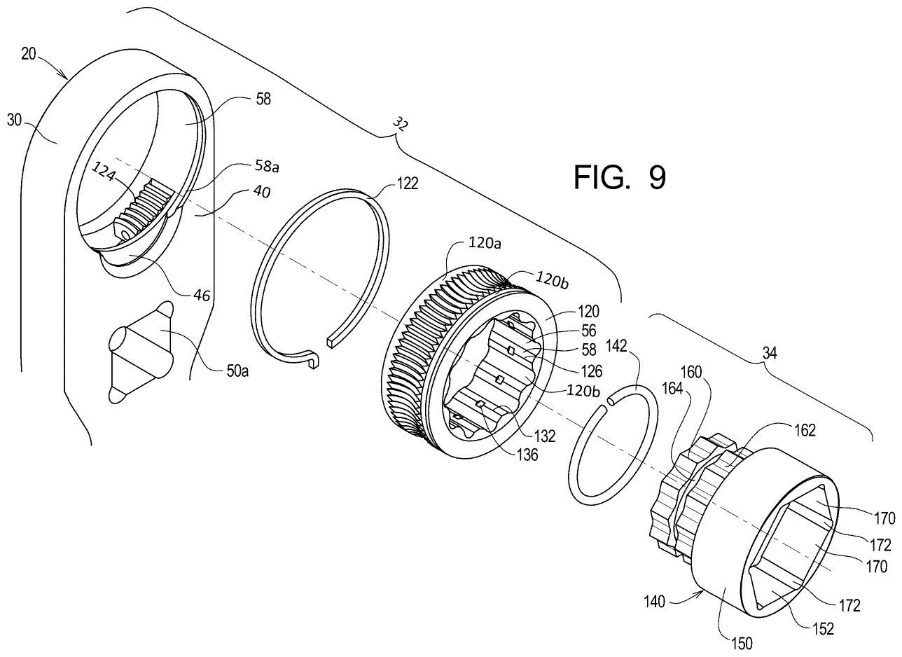

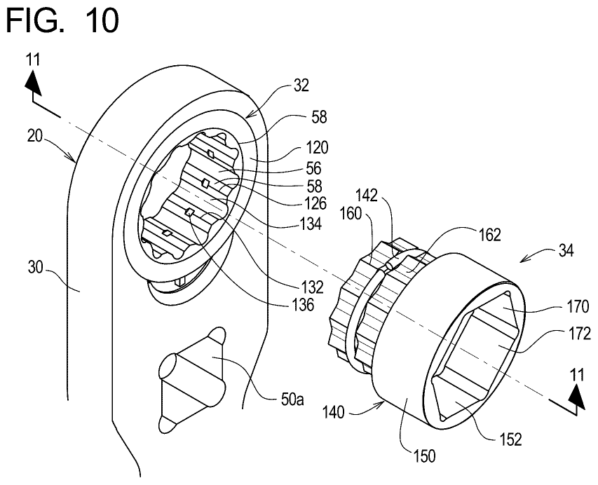

The example ratchet system 32 comprises a ratchet ring 120 (FIGS. 9-13, 16, and 17), a ratchet ring retaining clip 122 (FIGS. 9-13), a pawl 124 (FIGS. 9, 16, and 17), a pawl spring 126 (FIGS. 16 and 17), and a spring carriage 128 (FIGS. 16 and 17). The example ratchet ring 120 defines a ratchet ring external surface 120a and a ratchet ring internal surface 120b. The example pawl 124 is supported relative to the ratchet ring 120 and the tool body 30 such that the ratchet ring 120 may rotate in a first direction relative to the tool body 30 but is prevented from rotating in a second direction relative to the tool body 30. In particular, the pawl spring carriage 128 supports the pawl spring 126 such that the biases the pawl 124 into a position where teeth on the pawl 124 engage teeth on ratchet ring external surface 120a to allow relative axial rotation of the ratchet ring 120 in a first direction relative to the tool body 30 but not in a second direction opposite the first direction. The example ratchet system 32 is or may be conventional and will not be described herein beyond that extent helpful to a complete understanding of the present invention.

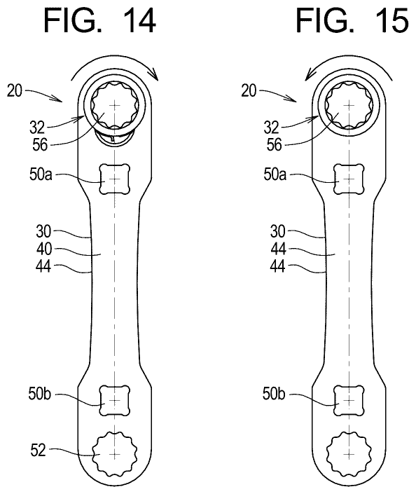

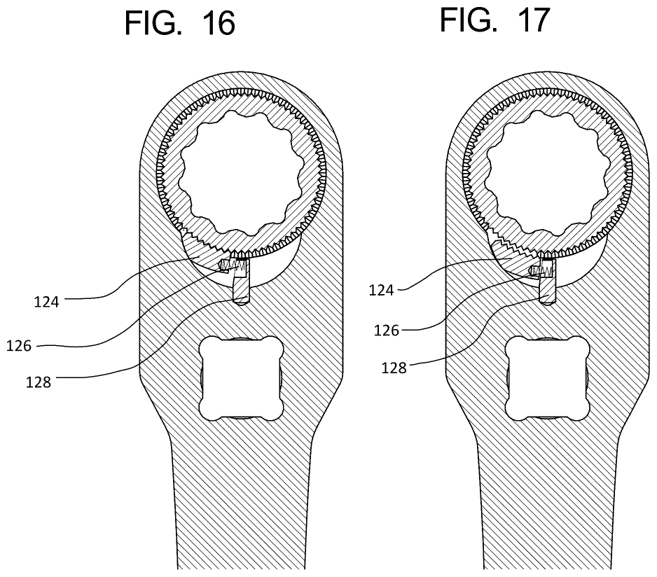

To rotate the part 22 in a first direction (e.g., clockwise), the socket assembly 34 is inserted into the ratchet system 32 on a first side of the tool body 30 and the part 22 is inserted into the socket assembly 34. The tool body is then displaced to rotate the part 22 in the first direction (e.g., FIG. 14). To rotate the part 22 in a second direction (e.g., counter-clockwise), the socket assembly 34 is inserted into the ratchet system 32 on a second side of the tool body 30 and the part 22 is inserted into the socket assembly 34. The tool body is then displaced to rotate the part 22 in the second direction (e.g., FIG. 15).

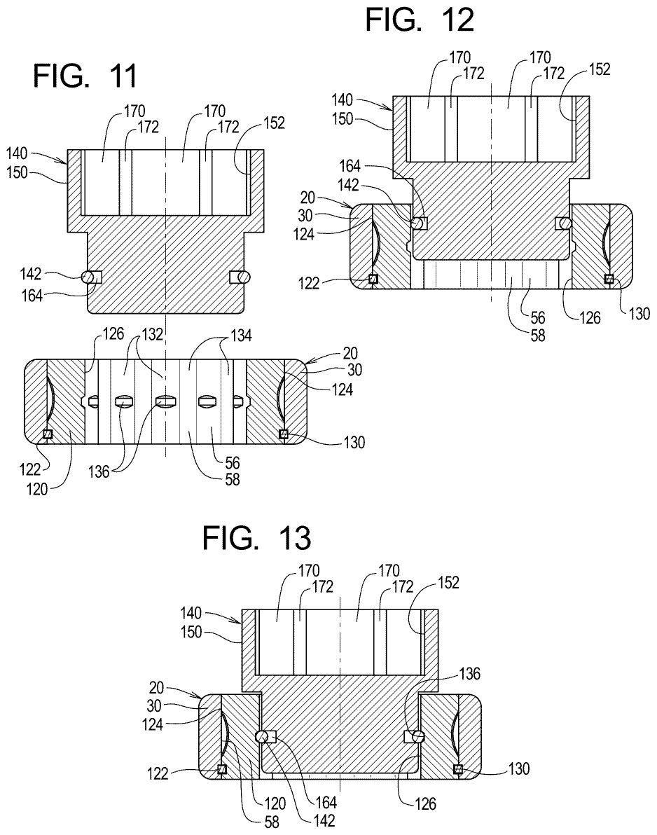

The example ratchet ring external surface 120a further defines a ratchet ring retaining groove 120b. When the ratchet system 34 is arranged within the ratchet transfer opening 56, the body retaining groove 58a is substantially aligned with the ratchet ring retaining groove 120b to define a retaining chamber 130 (see, e.g., FIGS. 11-13) sized and dimensioned to receive the ratchet ring retaining clip 122. The retaining chamber 130 intersects with the access notch 46 to allow the retaining clip 122 to be inserted into and removed from the retaining chamber 130 to assemble and disassemble the ratchet system 32 from the tool body 30.

In particular, one end of the retaining clip 122 is inserted into the retaining chamber 130 through the access notch 46, at which point the retaining clip is displaced such that the retaining clip 122 is entirely within the retaining chamber 130. With the retaining clip 122 at least partly within the retaining chamber 130, the retaining clip 122 inhibits movement of the ratchet ring 120 relative to the tool body 30. The retaining clip 122 may be removed from the retaining chamber 130 by displacing a first end of the retaining clip 122 and deforming the retaining clip 122 such that the first end thereof clears the access notch 46 and rides along the tool surface 40. Further displacing (e.g., rotating) the retaining clip 122 until a second end of the retaining clip 122 reaches the access notch 46 removes the retaining clip 122 from the retaining chamber 130 and allows movement of the ratchet ring 120 out of the ratchet transfer opening 56 relative to the tool body 30. At this point, the pawl 124 and/or pawl spring 126 and/or spring carriage 128 can be removed for repair or replacement.

The arrangement of the retaining chamber 130 relative to the access notch 46 facilitates removal of the ratchet system 32 so that the pawl 124 may be replaced if worn or broken.

The example ratchet ring internal surface 126 defines ratchet points 132 and ratchet recesses 134. A socket member retaining notch 136 is formed in at least one of the example ratchet points 132.

The example socket assembly 34 comprises a socket member 140 and a socket member retaining clip 142. The example socket member 140 defines a socket external surface 150 and a socket internal surface 152. The example socket external surface 150 defines socket member points 160 and socket member recesses 162. A socket member retaining groove 164 is formed in the example socket internal surface 152. Socket member drive surfaces 170 and socket member corner surfaces 172 are formed in the socket member internal surfaces 152. The example socket member drive surfaces 170 and socket member corner surfaces 172 are configured to define a conventional hex drive structure for transferring loads from the example adapter tool 20 to the part 22, but other drive structures may be used to transfer loads from the first example adapter tool 20 to the example part 22.

The example torque wrench system 28 and the example breaker system 26 forming the primary tool both define a drive portion 180. The drive portions 180 defined by the primary tool are configured to engage the drive openings 50a and 50b in the tool body. In particular, the example drive portions 180 each comprises a square drive projection 182 defining square drive surfaces 184. A detent system 190 is supported by the example square drive projection 182. The example detent system 190 is or may be a conventional ball detent system and comprises and a detent cavity 192 formed in at least one of the square drive surfaces 184 and a detent spring 194 and detent ball 196 supported by the detent cavity 192 such that the detent spring 194 biases the detent ball 196 out of the detent cavity 192.

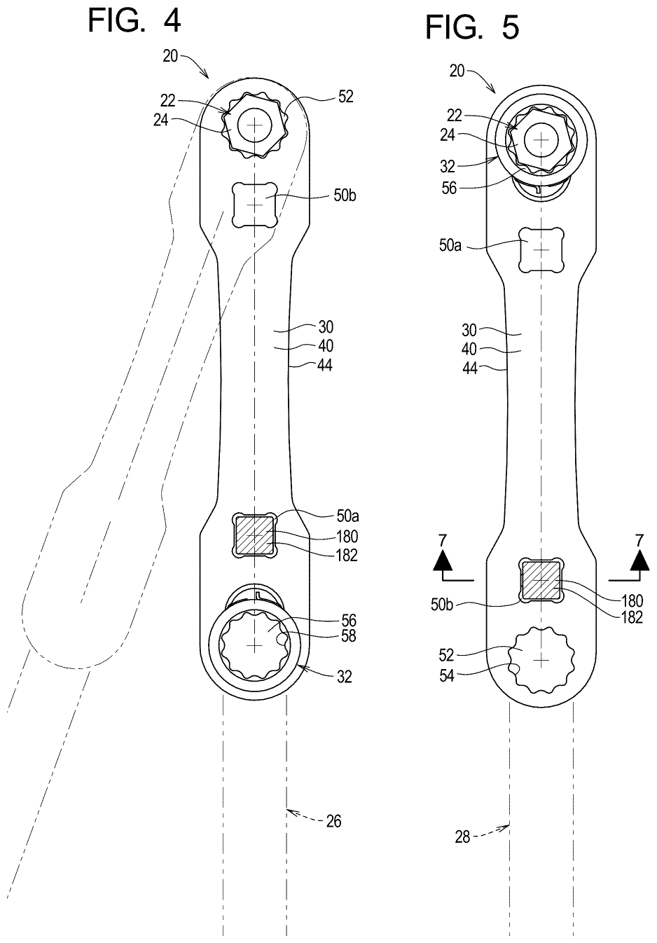

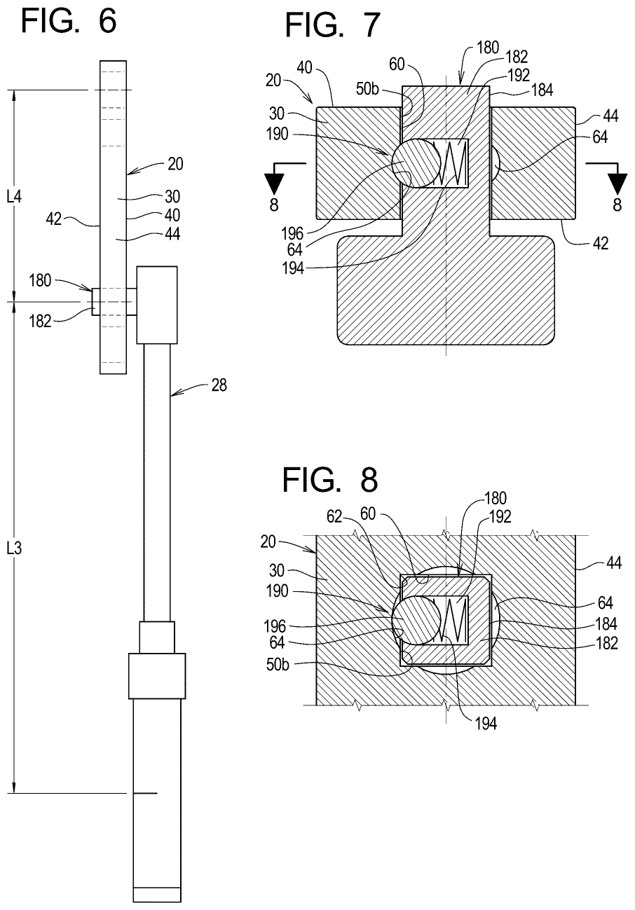

The example adapter tool 20 may be used in a removal mode (e.g., FIG. 4) and in an assembly mode (e.g., FIG. 5).

In the removal mode as shown in FIG. 4, the example breaker system 26 is arranged such that the drive portion 180 thereof engages the first drive opening 50a and the fixed transfer opening 52 is arranged to engage the part 22 to be removed. The detent spring 194 of the detent system 190 supported by the drive portion 180 will force the detent ball 196 into the retaining groove 64.

Application of force to an end of the breaker system 26 distal from the part 22 applies a rotational force to the part 22. The use of the first example adapter tool 20 in conjunction with the breaker system 26 in the removal mode employs leverage to increase the rotational force applied to the part 22. In addition, engagement of the drive portion 180 of the breaker system 26 with the first drive opening 50a and engagement of the fixed transfer opening 52 with the part minimizes movement between the breaker system 26 and the first example adapter tool 20 and between the first example adapter tool 20 and the part 22 that would otherwise reduce transfer of torque applied on the breaker system 26 to the part 22. The use of the first example adapter tool 20 in the removal mode in conjunction with the breaker system 26 thus optimizes removal of the part 22.

In the assembly mode as shown in FIG. 5, the example torque wrench system 28 is arranged such that the drive portion 180 thereof engages the second drive opening 50b, the ratchet system 32 supported in the ratchet transfer opening 56 is arranged to support the socket assembly 34, and the socket assembly 34 is arranged to engage the part 22 to be rotated. The torque wrench system 28 may be configured to apply a predetermined amount of torque to the part 22 based on knowledge of a length L3 associated with the torque wrench system 28 and a length L4 associated with the first example adapter tool 20. With the torque wrench system 28 appropriately configured, application of force to an end of the torque wrench system 28 distal from the part 22 applies a rotational force to the part 22.

The ratchet system 32 allows the torque wrench system 28 and first example adapter tool to rotate the part 22 in a first direction within a limited range to tighten the part 22, then in a second direction within that limited range without loosening the part 22, then again in the first direction within the limited range to further tighten the part 22. This process of displacing the torque wrench system 28 and the first example adapter tool alternately in the first and second directions is repeated until the part 22 is tightened to the predetermined amount of torque. At that point, the torque wrench system 28 will “release” to allow user to know that the predetermined amount of torque has been applied to the part 22.

If use of the torque wrench system 28 and the first example adapter tool 20 require the first direction of rotation of the part 22 to be reversed, the socket assembly may be arranged on the opposite side of the tool body as shown in FIGS. 14 and 15.

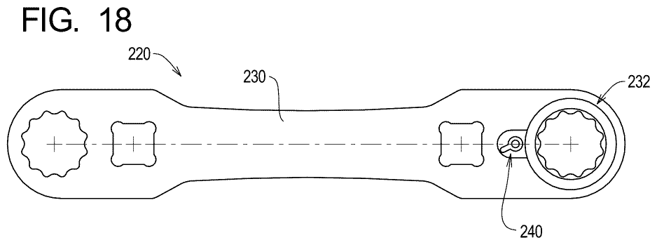

Turning now to FIG. 18 of the drawing, depicted therein is a second example adapter tool 220 constructed in accordance with, and embodying, the principles of the present invention. Except as noted below, the second example adapter tool 220 is constructed in the same manner as the first example adapter tool 120. The second example adapter tool 220 will be described herein only to that extent that the second example adapter tool 220 differs from the first example adapter tool 20.

The second example adapter tool 220 comprises a tool body 230 supporting a ratchet system 232. The ratchet system 232 comprises a ratchet selector lever 240 that allows the ratchet system to be reconfigured between one or more of a plurality of operational modes. In a first mode, the ratchet selector lever 240 may be configured to arrange the ratchet system 232 to operate in a conventional manner as described above. In a second mode, the ratchet selector lever 240 may be configured to lock the ratchet system 232 such that the ratchet system to prevent relative movement between the ratchet system 232 and the tool body 230. In a third mode, the direction of rotation allowed by the ratchet system 232 relative to the tool body 230 may be reversed.

What is claimed is:

1. An adapter system for a primary tool defining at least one drive portion configured to displace a part relative to a structure, the adapter system comprising:
a tool body defining first and second drive openings, a fixed transfer opening, and a ratchet transfer opening;
a ratchet system supported by the ratchet transfer opening; and
a socket assembly supported by the ratchet system; wherein the adapter system is configured to operate in at least one of a first mode and a second mode, where
in the first mode, the at least one drive portion is arranged in the first drive opening and the part is arranged in the fixed transfer opening, and
in the second mode, the at least one drive portion is arranged in the second drive opening and the part is arranged in the socket assembly.

2. The adapter system as recited in claim 1, in which:
the first drive opening is arranged between the fixed transfer opening and the ratchet transfer opening; and
the second drive opening is arranged between the fixed transfer opening and first drive opening.

3. The adapter system as recited in claim 1, in which:
the first and second drive openings define a retaining groove.

4. The adapter system as recited in claim 1, in which:
the retaining system comprises a ratchet ring and a rachet ring retaining clip configured to engage the rachet ring and the rachet transfer opening.

5. The adapter system as recited in claim 4, in which:
the retaining system comprises a ratchet ring defining a plurality of retaining notches.

6. The adapter system as recited in claim 5, in which:
the socket assembly comprises a socket member and socket member retaining clip configured to engage the socket member;
the socket member retaining clip is configured to engage the retaining notches.

7. The adapter system as recited in claim 1, in which:
the rachet system comprises a rachet selector lever configured to allow the rachet system to operate in at least one of first, second, and third rachet modes.

8. A method for adapting a primary tool defining at least one drive portion configured to displace a part relative to a structure, the method comprising the steps of:
providing a tool body defining first and second drive openings, a fixed transfer opening, and a ratchet transfer opening;
providing a ratchet system supported by the ratchet transfer opening; and
providing a socket assembly supported by the ratchet system;
configuring the tool body to operate in at least one of a first mode and a second mode to displace the part relative to the structure, where
in the first mode, the at least one drive portion is arranged in the first drive opening and the part is arranged in the fixed transfer opening, and
in the second mode, the at least one drive portion is arranged in the second drive opening and the part is arranged in the socket assembly.

9. The method as recited in claim 8, further comprising:
arranging the first drive opening between the fixed transfer opening and the ratchet transfer opening; and
arranging the second drive opening between the fixed transfer opening and first drive opening.

10. The method as recited in claim 8, further comprising:
configuring the first and second drive openings to define a retaining groove; and
configuring the retaining groove to engage at least a portion of the at least one drive portion of the primary tool.

11. The method as recited in claim 8, in which:
providing the retaining system comprises providing a ratchet ring and a rachet ring retaining clip.

12. The method as recited in claim 11, further comprising:
configuring the ratchet retaining clip to engage the ratchet ring and the rachet transfer opening.

13. The method as recited in claim 11, further comprising:
configuring the ratchet ring to define a plurality of retaining notches.

14. The method as recited in claim 13, in which:
providing the socket assembly comprises providing a socket member and socket member retaining clip configured to engage the socket member; and
configuring the socket member retaining clip to engage the retaining notches.

15. The adapter system as recited in claim 1, in which:
providing the rachet system comprises providing a rachet selector lever;
configuring the adapter system to allow the ratchet system to operate in at least one of first, second, and third rachet modes.

16. An adapter system for a primary tool defining a first system defining and a second system configured to displace a part relative to a structure, the adapter system comprising:
a tool body defining first and second drive openings, a fixed transfer opening, and a ratchet transfer opening;
a ratchet system supported by the ratchet transfer opening; and
a socket assembly supported by the ratchet system; wherein the adapter system is configured to engage the primary tool in at least one of a first mode and a second mode, where
in the first mode, at least a portion of the first system is configured to engage the first drive opening and the fixed transfer opening engages at least a portion of the part, and
in the second mode, at least a portion of the second system is configured to engage the second drive opening and the socket assembly is configured to engage at least a portion of the part; and
operation of the primary tool causes the adapter system to be displaced relative to the primary tool and the adapter system causes the part to be displaced relative to the structure.

17. The adapter system as recited in claim 16, in which:
the first drive opening is arranged between the fixed transfer opening and the ratchet transfer opening; and
the second drive opening is arranged between the fixed transfer opening and first drive opening.

18. The adapter system as recited in claim 16, in which:
the retaining system comprises a ratchet ring and a rachet ring retaining clip configured to engage the rachet ring and the rachet transfer opening.

19. The adapter system as recited in claim 18, in which:
the ratchet ring defines a plurality of retaining notches;
the socket assembly comprises a socket member and socket member retaining clip configured to engage the socket member;
the socket member retaining clip is configured to engage the retaining notches.

20. The adapter system as recited in claim 16, in which:
the rachet system comprises a rachet selector lever configured to allow the rachet system to operate in at least one of first, second, and third rachet modes.
